(19) United States
(12) Patent Application Publication
(10) Pub. No.: US 2007/0118497 A1
(43) Pub. Date: May 24, 2007

(54) LINKING OF IDENTICAL CHARACTER STRINGS IN DIFFERNT FILES

(76) Inventor: Naotaka Katoh, Fujisawa-shi (JP)

Correspondence Address: IBM CORPORATION;INTELLECTUAL PROPERTY LAW, 11400 BURNET ROAD, AUSTIN, TX, 78758, US

(21) Appl. No.: 11/554,054

(22) Filed: Oct. 30, 2006

(30) Foreign Application Priority Data
Nov. 22, 2005 (JP) 2005336746

(51) Int. Cl. G06F 17/30

(52) U.S. Cl. 707/1

(57) ABSTRACT

There is provided methods, machine-readable media, and systems for linking a character string in a first file with a character string in a second file, both of the character strings being stored in a memory of a computer, the character string in the second file being identical to the character string in the first file and enclosed by a first tag. In one embodiment, a method is provided which comprises adding a second tag to the character string enclosed by the first tag in the second file for indicating a location of the character string; and adding a link mark which specifies the second tag as a link destination to a character string in the first file, the character strings being identical to the character string enclosed by the first tag.

### CROSS-REFERENCE TO RELATED APPLICATIONS

The present application hereby claims priority of Japanese Patent Application No. JP 2005336746 filed on Nov. 22, 2005, and entitled “Linking of Identical Character Strings in Different Files”, which is incorporated by reference herein in its entirety for all purposes.

### BACKGROUND

1. Technical Field

The present invention generally relates to linking of an identical character string in different files and, more particularly, it relates to a computer program product and a computer system for linking identical character strings in different files.

2. Description of Related Art

Most of current computer program products (hereinbelow, referred to as programs) are predicated on an interaction with a user. The program uses character strings for communication with the user. This character string is generally referred to as a PII (Program Integrated Information) character string. These PII character strings are present in a text file separated from the program. In order to localize the program, it is necessary to translate the character string into each national language. Meanwhile, a manual of the program quotes the PII character string in its text body. A figure of GUI (Graphic User Interface) also includes the PII character strings.

When a PII character string in the program is updated (translated, changed), it is necessary to update the corresponding section of the related manual as well. In order to find the updated section in the manual, a global search function has been conventionally used to retrieve whether a corresponding PII character string exists or not. Here, the global search means for retrieving the character strings in a plurality of text files. It is commonly referred to as a GREP function.

However, when the PII character string in the text file separated from the program is changed, there is no telling which part of the text in the manual should be changed, or which GUI should be recaptured. As a result, in a current manual, the character string different from the PII character string in the program appears in the manual, thus making the user be confused. As for the GUI image, even when the manual describes that the program “outputs such GUI”, the translated PII which has been changed is outputted in fact, resulting in a problem that it does not correspond to the GUI in the translated manual.

This problem may not be solved only by the retrieval using the conventional global search function. In other words, since the conventional search method merely retrieves the character string using the PII character string, when character string patterns are the same, a character string which is not related to the PII character string may also be listed. For that reason, it is necessary to manually determine whether or not it is a character string related to the PII character string. Additionally, the larger the volume of the manual becomes, the longer the time, such as tens of seconds, to be required for the retrieval.

### BRIEF SUMMARY

The present invention provides a method, machine-readable medium, and system for linking a character string in a first file with a character string in a second file, both of the character strings being stored in a memory of a computer, the character string in the second file being identical to the character string in the first file and enclosed by a first tag. In one embodiment, such a method is provide which comprises adding a second tag to the character string enclosed by the first tag in the second file for indicating a location of the character string; and adding a link mark which specifies the second tag as a link destination to a character string in the first file, the character strings being identical to the character string enclosed by the first tag.

In various embodiments of the present invention, a link of a specific character string in a first file with a specific character string in a second file is provided, so that, without investigating many character strings other than the character string of a specific type, an updated location of the character string of the specific type in the link destination can be found out. Alternatively, a link of a specific character string in a program with a specific character string in a corresponding manual is provided, so that an update of the specific character string can be immediately reflected onto the corresponding character string in the manual. As a result, a high quality manual which quotes the specific character string can be continuously maintained.

### BRIEF DESCRIPTION OF THE DRAWINGS

FIG. 1 is a block diagram illustrating a configuration of a computer system according to an embodiment of the present invention;

FIG. 2 is a block diagram illustrating second tag adding means and link mark adding means according to an embodiment of the present invention;

FIG. 3 is a view illustrating an example of contents of a PII character string file (list) according to an embodiment of the present invention;

FIG. 4 is a view illustrating an example of a portion of a manual in an HTML format (HTML file) according to an embodiment of the present invention;

FIG. 5 is a view illustrating an example of a PII text file according to an embodiment of the present invention;

FIG. 6 is a view illustrating an example of a portion of an intermediate list table according to one embodiment of the present invention; and

FIG. 7 is a view illustrating a finally created PII text file and its link according to an embodiment of the present invention.

### DETAILED DESCRIPTION AN ILLUSTRATIVE EMBODIMENT

Hereinafter, embodiments of the present invention will be described, by taking a PII character string used in a program and a manual as an example. The present invention is not limited to the PII character string used in the program and the manual, but is also applicable to the specific character string used among other different files. Moreover, a tag is not limited to an HTML tag, but tags in other formats can also be used.

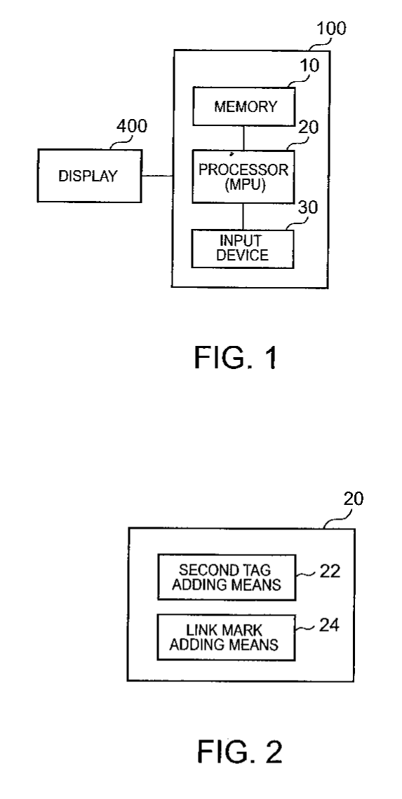

FIG. 1 is a block diagram illustrating a configuration of a computer system according to an embodiment of the present invention. The computer system 100 includes a memory 10, a processor 20, and an input device 30. The computer system 100 also includes an external or internal display 40. The memory 10 stores a first computer program product and a manual of the program product. The processor 20 can extract, from the first computer program product, a plurality of character strings which can be displayed on the display 40 of the computer 100 to create a text file including a plurality of character strings. The processor comprises, for example, a microprocessor unit (MPU). The input device 30 is used to add a first tag to a character string in the manual, which is identical to the character string. The input device 30 includes a keyboard, a mouse, a track ball, or an audio input device.

The memory 10 further stores a second computer program product. The second computer program product is executed by the processor 20 to cause the processor itself to operate as a second tag adding means 22 and a link mark adding means 24 as shown in FIG. 2. The second tag adding means 22 has a function for adding a second tag to the character string in the manual, to which the first tag is added, for indicating the location of the character string. The link mark adding means 24 has a function for adding a link mark which specifies the second tag as a link destination to the character string in the text file, which is identical to the character string to which the second tag is added.

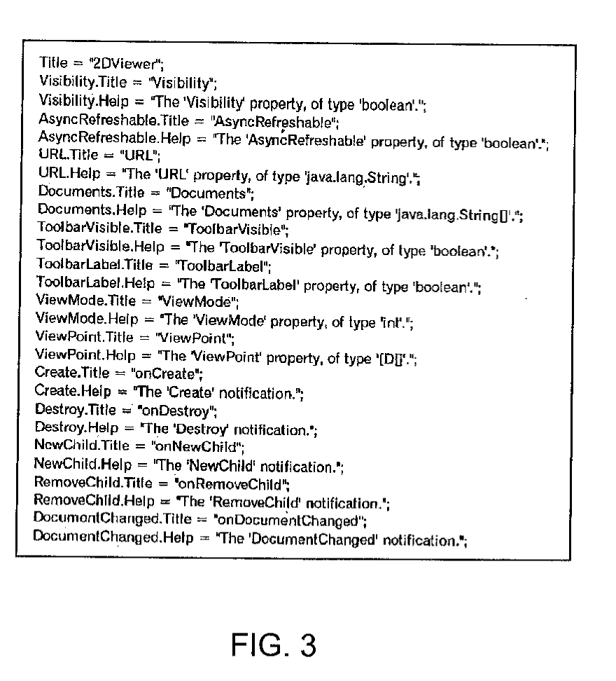

The character string in the text file includes, for example, a PII (Program Integrated Information) character string. FIG. 3 illustrates an example of contents of the PII character string file (list). The manual includes, for example, a file in an HTML (Hypertext Markup Language) format (HTML file). The first tag includes, for example, a keyboard tag (<kbd> . . . </kbd>) which is one of the HTML tags, and the second tag includes, for example, an anchor tag (<A> . . . </A>). The link mark includes, for example, a hyperlink (HTML). Moreover, the PII character string includes such as the PII character string in the original language (for example, English) and the PII character string translated into a different language (for example, Japanese). Note herein that, since other tags such as a <code> tag or a <sampl> tag are likely to be used also for the character string which is less related to the PII, the use thereof may not be preferred. Meanwhile, since the <kbd> tag is unlikely to be used for the character string which is less related to PII, it may preferably be used. Actually, as a rule for HTML creation, the <kbd> tag is used limitedly to the character on GUI. When the tags such as <pii> . . . </pii> limited to the character on the computer screen are made in the future, however, they may be used.

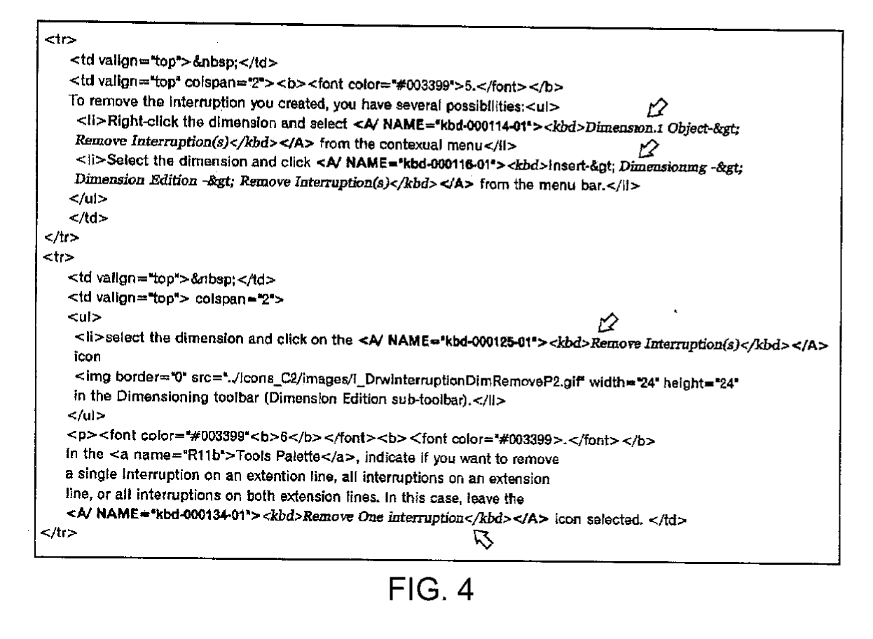

FIG. 4 illustrates an example of a portion of the manual in the HTML format (HTML file). In the portion of NAME=″″ within the anchor tag (<A> . . . </A>) in FIG. 4, a name (ID) for specifying the keyboard tag (<kbd> . . . </kbd>) is inputted. For example, “kbb-000114-01” in FIG. 4 indicates that it is the first tag of 114th line in the HTML file. Other IDs may similarly be determined. The anchor tag is added to the file resulted from the execution of the second computer program product. The keyboard tag (<kbd> . . . </kbd>) is added, upon creating the manual, to specify that it is the PII character string displayed on the computer display. In the example shown in FIG. 4, the first three of them are the PII “Remove Interruption (s)”, and the last one is the PII “Remove One Interruption.” This keyboard tag is added to the file upon creating the manual.

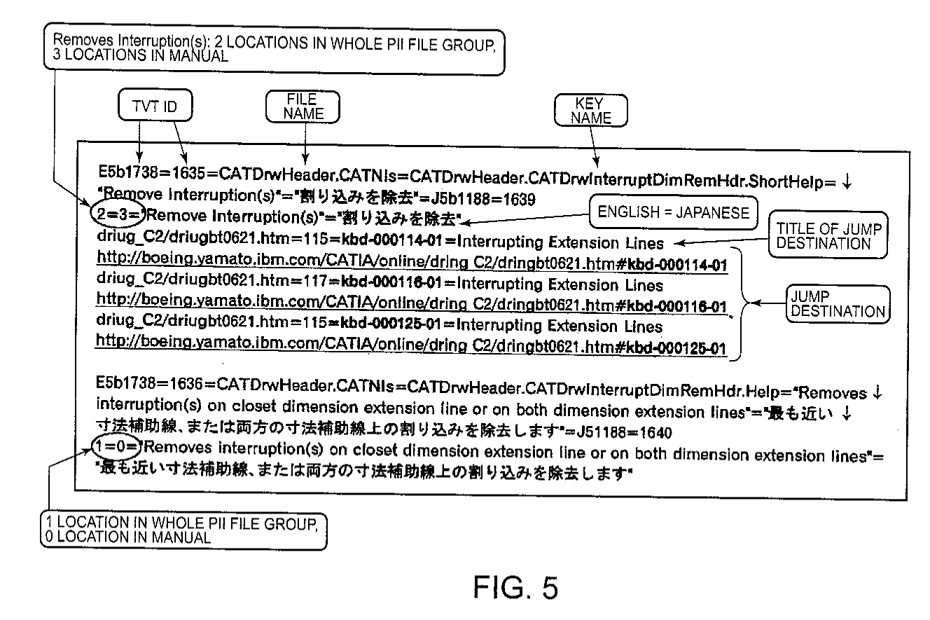

In addition, the text file includes the list configured by the plurality of PII character strings. The list may include the PII character string in the original language, the translated PII character string, a title of the link destination in the HTML file, and the hyperlink to the link destination, as a set, for each PII character string. FIG. 5 illustrates an example of the text file. The PII character string “Remove Interruption(s)” is connected to its Japanese translation “(equivalent JAPANESE WORDS)”. In this case, this PII character string appears at two locations in the whole text file. In the HTML file (manual), it is referenced to at three locations. The reference locations (link destinations) (1, 2, 3) are described as underlined hypertext links. Numerals in the link destinations “kbb-000116-01”, “kbb-000114-01”, and “kbb-000125-01” correspond respectively to the IDs (line, order in the line) in each tag in the HTML file shown in FIG. 4. As henceforth described, by clicking the hyperlink, it jumps to the link destination specified by each ID in the manual in the HTML format. FIG. 5 illustrates a portion of the text file. The whole file includes a number of configurations similar to that shown in FIG. 5 before and after that to constitute one long list.

Hereinbelow, an embodiment of the present invention will be described in more detail. The text file of a link source and the HTML file of the link destination are prepared using the following procedure. Both of the text file of the PII and the HTML manual to be prepared are created by copying from the original file (program) of the PII and the original manual. The overall procedure is performed by the program (second computer program product) except for preparation on the manual side (1) described below.

<Preparation on Manual Side>

(1) Upon creating the original manual in the HTML format, the character string (PII character string) on the computer screen is enclosed by the keyboard tag <kbd> . . . </kbd>. (This operation is a rule for manual creation.)

(2) For the completed manual, the anchor tag <A NAME= . . . >is inserted right before the <kbd> tag. NAME of the anchor tag is set to an ID corresponding to the <kbd> tag. For example, as described above, if the <kbd> tag is the first tag of the 53rd line in the html text file, the ID will be set to “kbd-000053-01”.

<Preparation on PII Text File Side>

(3) The whole PII is set into one text file in the format in accordance with a certain rule to create a list.

(4) The PII character strings are sequentially extracted from the created PII list.

(5) The character string in the manual, which is identical to the extracted PII character string and enclosed by the <kbd> tag is retrieved.

(6) If there is the identical character string, the hyperlink with the anchor tag right before the <kbd> tag as the jump destination is created.

(7) The link information along with the information in the PII list of the above Preparation (1) is added to the text file as a final result. If there are a plurality of character strings, which are identical and are enclosed by the <kbd> tag, a plurality of pieces of link information therein are written.

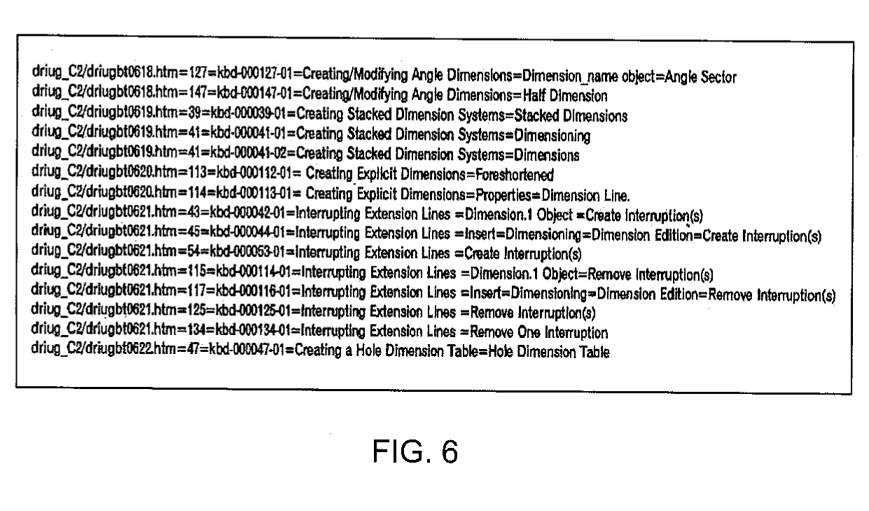

(8) However, since the list of, for example, “Yes” which appears frequently is too voluminous and thus becomes an obstacle upon referencing to the text file, an item which has, for example, 50 reference destinations or more is not referenced to and specially processed. Note herein that, the search time of the HTML character strings is shortened by creating an intermediate list table used for the search of the whole manual. The anchor tag inserted in the HTML file as the ID will play an important role for this purpose. FIG. 6 illustrates an example of a portion of the intermediate list table. The list table uses “=” as a delimiter. Using the list table enables the processing speed as 5000 times fast as the search without utilizing the tag.

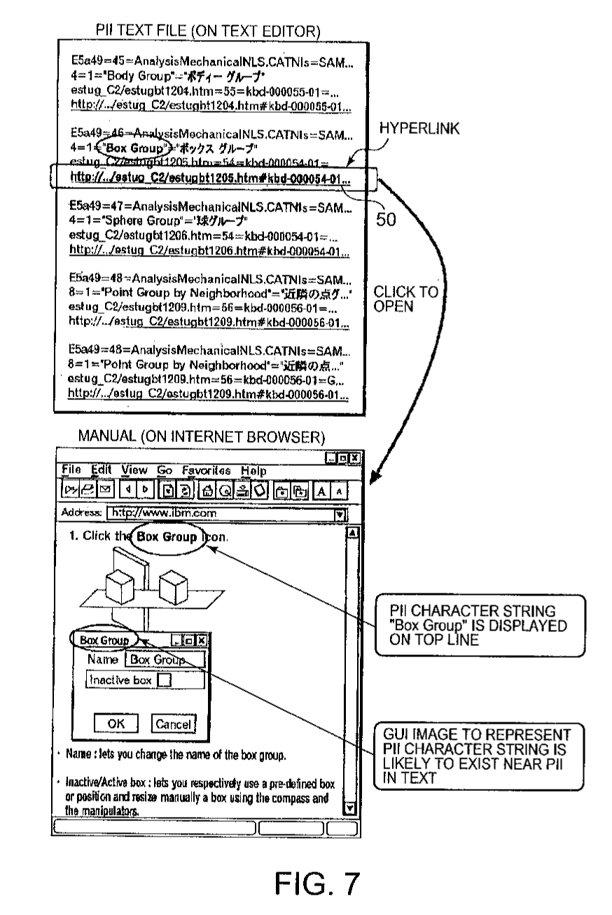

(9) Finally, the prepared HTML file is stored in the memory of the computer for the HTML (HTML server). The final text file is opened by a user who actually references to the PII character string using a text editor, and jumps from a specific PII character string to the HTML file to confirm the contents of the manual of the jump destination. FIG. 7 illustrates the finally created text file and its link. The upper figure in FIG. 7 illustrates a state when the file is opened by the text editor. The same paragraph configurations are repeated. The paragraphs are divided by a blank line, where one paragraph includes one PII. A click may open a click destination of the manual in the HTML format. In FIG. 7, by clicking a hyperlink 50, a section to display the PII character string “Box Group” in the manual appears on the screen.

<Format That Has Actually Been Used>

A PII text file format will be hereinbelow illustrated. The fundamental configuration is similar to that shown in FIG. 5. Here, the character string format separated with an equal sign is used. Note herein that, “ . . . ” indicates omission. A portion with an underline in the last line represents the hyperlink.

E5a49=46=AnalysisMechanicalNLS.CATNls=SAM . . .

4=1=“Box Group”=“(equivalent JAPANESE WORDS)”

estug_C2/estugbt1205.htm=54=kbd-000054-01= . . .

http:// . . . /estug_C2/estugbt1205.htm#kbd-000054-01

The first line: E5a49 is a TVT (Translation Verification Test) ID for the PII, including English (E), Release15 (5), GM (a), and a file number 49, followed by a line number 46, a file name, and a key name in that order.

The second line: symbol “4” indicates that the four keys define the identical character string “Box Group” in the whole PII. Symbol “1” indicates that “Box Group” appears at only one location in the manual. It is followed by the English character string and the character string of the Japanese translation.

The third line: From the left, it is followed by a folder name and the file name of the HTML file, the line number in the file at which the <kbd> tag appears, and the ID of the <kbd> tag. The last “01” of the ID of the <kbd> tag indicates that it is the first <kbd> tag of the line. In this example, the search is performed to the English manual by English “Box Group” of the second line. The fourth line: It is the hyperlink to the manual. When actually used, it is necessary to replace all the addresses at the higher order in accordance with the address of an http server.

According to the aforementioned embodiment of the present invention, the following effects can be provided.

<Effects of Using Keyboard Tag <kbd>>
(a) A character string serving as a target in the manual can be limited to the PII character string with the <kbd> tag.
(b) While the use of the <kbd> tag is effective for finding “a chain of the PII”, it also has an effect capable of notifying the user that it is the character string in the GUI using CSS (Cascading Style Sheet).
(c) The embodiment of the present invention is also applicable to the already completed HTML manual. It is also possible to apply only from, for example, an important manual.

<Effects of Using Anchor Tag <A>>
(a) Inserting the anchor tag makes it possible to implement a hyperlink from the text file to the corresponding section. By utilizing the anchor tag name (NAME=ID), the ID can be attached to the position of the PII character string in the manual.
(b) Creating the intermediate list table by utilizing the anchor tag makes it possible to significantly reduce the search time. The intermediate list table includes the HTML holder and file name of the manual, and the ID of the aforementioned anchor tag and the character string in the <kbd> tag. Since each PII character string performs the search processing to the intermediate list table, the processing which takes approximately 30 days without utilizing the tag will be completed within 10 minutes or less.

<Effects of list due to simple text format>
(a) Since the reference destination is preliminarily prepared for each of the keys in the PII file as the list, there is no latency time in search by the Grep or the like, thus allowing the overall situation to be easily understood. For example, the following situations will be known at a glance.—How many identical character strings are there in all the PII keys?13 How many target character strings are there in the manual?—Are the identical character strings concentrated in the same file in the manual or distributed in various files or holders?
(b) Since the link can be created from the text editor to the corresponding section in the manual through the hyperlink, the operation efficiency in displaying the character string in the manual is high.
(c) Without preparing a particular program, the function of the text editor (for example, K2 Editor) can be utilized. Since the whole PII is collected into one simple text data to thereby create the link, the flexibility (degree of freedom) in editing is high, so that the function such as text search (including regular expression search) of the Editor, the Grep, or the hyperlink, can be utilized freely.
(e) Specification of the PII text (final list) can be changed very easily.

Furthermore, according to an embodiment of the present invention, the following effects may be provided especially from the user side.
(a) While it takes 30 days to obtain the detection result in detecting the character string the same as that of the Grep for the manual with large volume, all the preparations will be completed within approximately 10 minutes according to the embodiment of the present invention. It is because that creating the list table of the PII character strings in the manual and the location of the link destination make a significant improvement in search efficiency.
(b) It is not necessary to manually recognize and eliminate a large number of character strings which are unrelated to the character string on the screen (PII character string) but which happen to be identical to the character string on the screen.
(c) If there is a change in the PII translation, the section using the PII character string in the manual can be readily found out. Since the section in the manual translated into Japanese can also be immediately found out by the link, the mismatch between the program and the manual can be prevented.
(d) It becomes possible to directly jump from the list of the whole PII to the specific section in the manual relevant to the specific PII character string, thus allowing the section using the PII in the manual to be easily found out. When translating the PII character string without the context, the context for which the character string is used in the manual can be known, so that the PII can be correctly translated. Most of the program products require the translation of the PII, so that the effect of enabling the PII to be correctly translated is significant.

What is claimed is:

1. A method for linking a character string in a first file with a character string in a second file, both of the character strings being stored in a memory of a computer, the character string in the second file being identical to the character string in the first file and enclosed by a first tag, said method comprising:
adding a second tag to the character string enclosed by the first tag in the second file for indicating a location of the character string; and
adding a link mark which specifies the second tag as a link destination to a character string in the first file, the character strings being identical to the character string enclosed by the first tag.

2. The method of claim 1, wherein the character string includes a program integrated information character string.

3. The method of claim 2, wherein said method is performed by a first computer program product, the first file includes a list including a plurality of program integrated information character strings extracted from a second computer program product, and the second file includes a manual of the second computer program product.

4. The method of claim 3, wherein the manual of the second computer program product includes a file in an HTML format, the first tag includes a tag indicating a character on a computer screen, the second tag includes a tag indicating the link destination, and the link mark includes a hyperlink.

5. The method of claim 4, wherein the manual of the second computer program product includes the file in the HTML format, the first tag includes a keyboard tag, the second tag includes an anchor tag, and the link mark includes a hyperlink.

6. The method of claim 4, wherein the program integrated information character string includes a program integrated information character string in an original language and a program integrated information character string translated into a different language.

7. The method of claim 6, wherein the list including a plurality of program integrated information character strings includes the program integrated information character string in the original language and the hyperlink to the link destination, as a set, for each program integrated information character string.

8. The method of claim 6, wherein the list including a plurality of program integrated information character strings includes the program integrated information character string in the original language, the translated program integrated information character string, a title of the link destination in the HTML file, and the hyperlink to the link destination, as a set, for each program integrated information character string.

9. A machine-readable medium having a plurality of instructions executable by a machine embodied therein, wherein said plurality of instructions, when executed, cause said machine to perform a method for linking a character string in a first file with a character string in a second file, both of the character strings being stored in a memory of a computer, the character string in the second file being identical to the character string in the first file and enclosed by a first tag, said method comprising:
adding a second tag to the character string enclosed by the first tag in the second file for indicating a location of the character string; and
adding a link mark which specifies the second tag as a link destination to a character string in the first file, the character strings being identical to the character string enclosed by the first tag.

10. The machine-readable medium of claim 9, wherein the character string includes a program integrated information character string.

11. The machine-readable medium of claim 10, wherein said method is performed by a first computer program product, the first file includes a list including a plurality of program integrated information character strings extracted from a second computer program product, and the second file includes a manual of the second computer program product.

12. The machine-readable medium of claim 11, wherein the manual of the second computer program product includes a file in an HTML format, the first tag includes a tag indicating a character on a computer screen, the second tag includes a tag indicating the link destination, and the link mark includes a hyperlink.

13. The machine-readable medium of claim 12, wherein the manual of the second computer program product includes the file in the HTML format, the first tag includes a keyboard tag, the second tag includes an anchor tag, and the link mark includes a hyperlink.

14. The machine-readable medium of claim 12, wherein the program integrated information character string includes a program integrated information character string in an original language and a program integrated information character string translated into a different language.

15. The machine-readable medium of claim 14, wherein the list including a plurality of program integrated information character strings includes the program integrated information character string in the original language and the hyperlink to the link destination, as a set, for each program integrated information character string.

16. The machine-readable medium of claim 14, wherein the list including a plurality of program integrated information character strings includes the program integrated information character string in the original language, the translated program integrated information character string, a title of the link destination in the HTML file, and the hyperlink to the link destination, as a set, for each program integrated information character string.

17. A computer system comprising:
a processor to process data and to execute instructions; and
a memory, coupled to said processor, to store said data and said instructions, wherein said instructions, when executed, cause said computer system to perform a method for linking a character string in a first file with a character string in a second file, both of the character strings being stored in a memory of a computer, the character string in the second file being identical to the character string in the first file and enclosed by a first tag, said method comprising:
adding a second tag to the character string enclosed by the first tag in the second file for indicating a location of the character string; and
adding a link mark which specifies the second tag as a link destination to a character string in the first file, the character strings being identical to the character string enclosed by the first tag.
